(19) United States
(12) Patent Application Publication
(10) Pub. No.: US 2005/0206220 A1
(43) Pub. Date: Sep. 22, 2005

(54) Method for covering the visible portions of the wheel of a vehicle

(76) Inventor: John G. Polka, Libertyville, IL (US)

Correspondence Address: ROBERT L. MARSH, 54 DANADA DRIVE, P.O. BOX 4468, WHEATON, IL, 60187-4468, US

(21) Appl. No.: 10/792,119

(22) Filed: Mar. 3, 2004

(51) Int. Cl. B60B 7/00

(52) U.S. Cl. 301/37.105

(57) ABSTRACT

A cover for a wheel having a web with an outer surface includes a cover body having a web with a rear surface complementary in shape to the outer surface of the web of the wheel. The parts can be nested with the rear surface of the wheel cover abutting against the outer surface of the web of the wheel. The two parts are nonremovably bonded to each other so that the wheel liner stays joined to the wheel when the wheel is removed from the vehicle.

The present invention relates to a covering for the exterior surfaces of a vehicle wheel to improve its appearance and in particular to a non-removable wheel covering.

### BACKGROUND OF THE INVENTION

It is a common desire for vehicle owners who take pride in their vehicle to improve the appearances of the vehicle. Often, the most unsightly portion of a vehicle is the wheels, because the wheels are functional. Automobile manufacturers customarily provide wheels covers for their vehicles to enhance the appearance of the wheels, but wheel covers are not generally provided by the manufacturers of trucks and therefore truck wheels do not have surfaces adapted to retain a wheel cover thereto. The wheel covers for trucks, therefore, are provided by aftermarket manufacturers and the wheel covers they provide must attach to the function portions of the wheel.

There are many methods for attaching a wheel cover to the functional portions of a wheel. The wheel cover may have a plurality of spaced holes for receiving the threaded studs that retain the wheel to the axle of the vehicle such that the studs and nuts which retain the wheel to the hub of the vehicle also retain the wheel cover. Certain states, for example California, however, require that truck wheels be periodically inspected for cracks that occur in the vicinity of the holes that receive the studs. Where portions of the web are covered by the retainer for retaining the wheel cover, the retainer must be removed to inspect the web in the proximity of the holes. The nuts that retain such wheels to the hub of trucks are installed using a pneumatic or hydraulic tool and therefore the removal of lug nuts retaining a wheel to expose the underlying web require that the truck go off-road to a remote location. As a result, the use of the studs and lug nuts which retain the wheel to a truck to retain a cover can cause an unacceptable delay in the use of the truck.

Another method for retaining a cover to a truck wheel is disclosed in my previously issued U.S. Pat. No. 5,630,653 issued May 20, 1997 in which an attachment plate is provided having arcuate portions that fit under the corners of a lug nut. Such an attachment can be removed without requiring the removal of the lug nut that holds the wheel to the vehicle.

Another method of retaining a wheel is disclosed in my U.S. Pat. No. 6,595,961 B1 issued in which a retainer is connected to portions of the threads of one or more studs that extend beyond the lug nut that retains a wheel to an axle hub. A third method of retaining a wheel is disclosed in my U.S. Pat. No. 5,823,635 in which the wheel is attachable to hand holds provided in the web of the wheel. Yet another method of attaching a wheel is disclosed in my U.S. Pat. No. 6,443,528 in which retaining brackets are provided that extend into a drop center of a truck wheel. In all of these methods, the wheel covers and their retainers can be removed without requiring the removal of the nut threaded onto the studs that retain the wheel to the vehicle.

Existing wheel covers for vehicles, including automobile wheel covers, must be removed before the wheel itself can be removed. In the case of truck wheels, the apparatus that retains the cover to the truck wheel can be complex and time consuming to remove before the wheel can be removed from the vehicle, and time consuming to reinstall the cover after the wheel has been replaced. It would be desirable, therefore, to provide a wheel covering which can be permanently attached to a wheel and will improve the appearance of the visible portions of the wheel, and will continue to be retained to the wheel when the wheel is removed from the vehicle. To comply with the laws of various states requiring the inspection of a wheel in the vicinity of the holes that receive the studs it is desirable that the wheel liner not conceal the portions of the wheel that may require inspection.

### SUMMARY OF THE INVENTION

Briefly, the present invention is embodied in a method for covering the visible portions of a wheel of a vehicle. The vehicle may be that of automobile or that of a truck, or any other vehicle for which one desires to enhance the visible portions of the wheel. In the case of the rear wheels of a truck, the wheel has a tubular rim portion, having an inner surface that is visible from the exterior of the truck and a web portion having an outer surface which is also visible from the exterior of the truck.

In accordance with the invention, a wheel liner is provided having a generally tubular portion, the outer surface of which is generally complementary in shape to the visible inner surface of the tubular rim, and across the rearward end of the cylindrical portion of the cover is a generally planar web that is complementary in shape to the outer surface to the outer surface of the web of the wheel to which it is attachable. The tubular portion of the wheel liner is adapted to permit the rearward surface of the web of the wheel liner to abut against the outer surface of the web of the wheel and is nonremovably retained in abutting relationship by a bonding material. To ensure that the portions of the wheel in the proximity of the holes for receiving lug nuts are not concealed, the wheel liner will preferably have a plurality of spaced openings around the central portions of the liner positioned to receive the threaded studs with the diameters of the holes being sufficiently large to permit inspection of the underlying wheel in the proximity of the lug nut.

Where the rear wheel of the truck is adapted to receive a tubeless tire, as is the case with most wheels, the wheel will have a drop center having an inner diameter that is smaller than an inner diameter taken rearward of the drop center. In order to provide a wheel liner that is insertable into a wheel having a drop center, the wheel liner must have a cylindrical portion, the outer diameter of which is no larger than the inner diameter of the dropped center. Accordingly, the tubular portion of the wheel between the drop center and the web will not abut against the inner surface of the wheel. A suitable bonding material, such as a double sided adhesive tape, positioned between the web of the wheel and the web of the wheel liner retains the wheel cover to the wheel.

It should also be appreciated that in order to remove a tire from a wheel, a tool must engage the curled outer rim of the wheel and therefore a wheel cover in accordance with the present invention must not cover the portions of the curl at the rim of the wheel that is engagable by the tool.

### BRIEF DESCRIPTION OF THE DRAWINGS

A better understanding of the present invention will be had after a careful reading of the following detailed description taken in conjunction with the drawings wherein:

FIG. 1 depicts an exploded cross-sectional view of a wheel having a wheel cover in accordance with the present invention inserted therein;

FIG. 2 is an assembled cross-sectional view of the wheel cover and wheel shown in FIG. 1;

FIG. 3 is an exploded cross-sectional view of a wheel having a wheel cover in accordance with a second embodiment of the invention;

FIG. 4 is an assembled cross-sectional view of the wheel cover and wheel shown in FIG. 3;

FIG. 5 is an exploded cross-sectional view of a wheel having a wheel cover in accordance with a third embodiment of the invention;

FIG. 6 is an assembled cross-sectional view of the wheel cover and wheel shown in FIG. 5;

FIG. 7 is an exploded cross-sectional view of a front wheel of a truck having a wheel cover in accordance with the invention attached thereto; and

FIG. 8 is an assembled cross-sectional view of the wheel and wheel cover shown in FIG. 7.

### DETAILED DESCRIPTION OF A PREFERRED EMBODIMENT

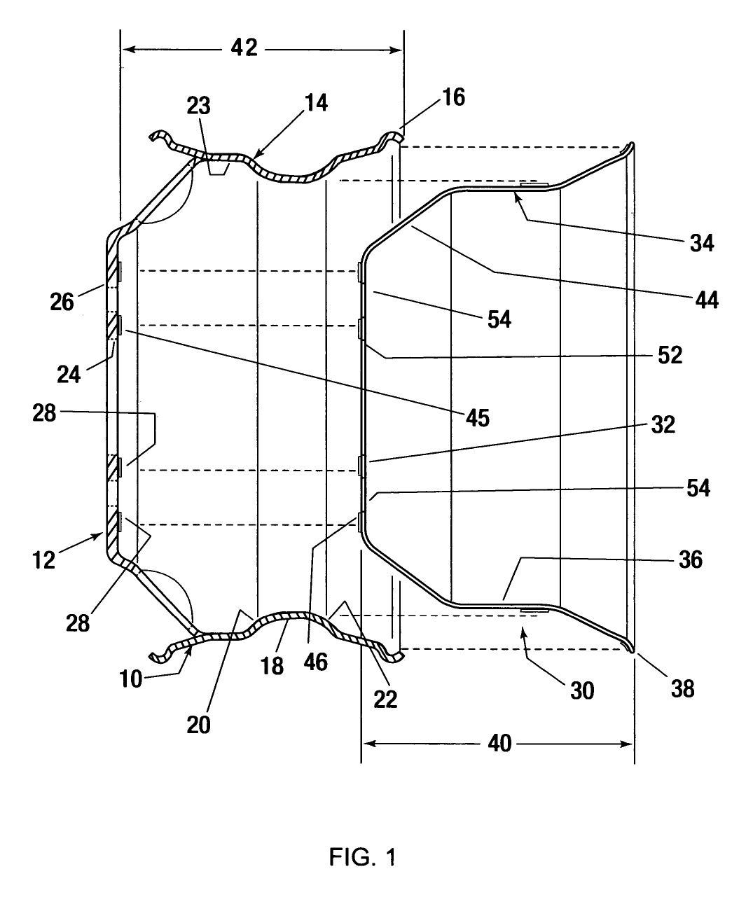

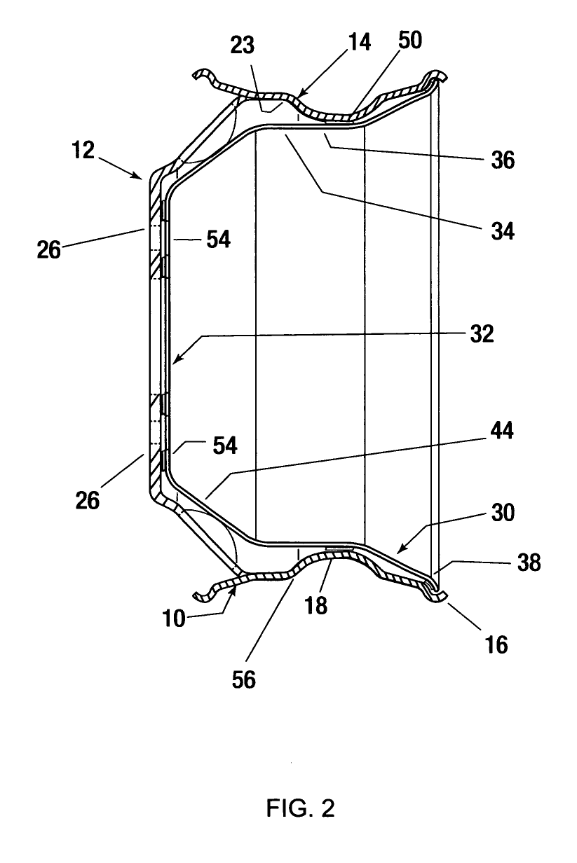

Referring to FIGS. 1 and 2, a wheel 10 has a generally circular, planar web 12 and a generally tubular rim 14 at the outer end of which is a curled lip 16 adapted to retain the bead of a tire, not shown. Where the wheel 10 is intended to receive a tubeless tire, the rim 14 will have a drop center 18 that forms an inner shoulder 20 and an outer shoulder 22. The inner diameter of the web at the drop center 18 is less than the inner diameter taken outward of the outer shoulder 22, and less than the maximum inner diameter of the rim inward of the inner shoulder 20, such that the inner shoulder 20 creates a pocket or indentation behind the drop center 18. The wheel 10 also has a circular central opening 24 through which the central portion of a hub of a wheel, not shown, extends. The wheel 10 also has a plurality of spaced holes 26-26 around the central opening 24 for receiving a corresponding plurality of parallel spaced threaded studs, not shown, extending from the hub at the distal end of the axle of a vehicle. For most truck wheels, the outer surface 28 of the web 12 of the wheel 10 is planar as shown.

For the purposes of this discussion, the elements of a wheel and wheel liner that are positioned outward of the vehicle to which they are attached will be described as “forward” and the portions of the wheel or wheel or wheel liner that are directed toward the vehicle to which they are attached will be referred to as “rearward.”

A wheel liner 30 in accordance with the invention has a generally planar web portion 32 and extending forwardly from the outer circumference of the web portion 32 is a tubular portion 34. The wheel liner 30 is preferably made of a stamped metal having an outer shape adapted to slide within the interior of the cavity formed by the rim 14 of the wheel 10. In the preferred embodiment, the tubular portion 34 of the liner 30 has a central portion 36, the outer diameter of which is a little smaller than the inner diameter of the dropped center 18 of the rim 16, such that the rearward portions of the wheel liner 30 will snugly slide inside the dropped center 18 of the wheel 10. At the forward edge 38 the diameter of the tubular portion 34 is a little less than the inner diameter of the lip 16 at the outer end of the rim 14 of the wheel 10. The tubular portion 34 has an axial length 40 which is a little less than the axial length 42 of the inner portions of the rim 16 of the wheel 10. The tubular portion 34 of the wheel liner 30 also has a tapering portion 44 between the central portion 36 and the web 32 adapted to permit the wheel liner 30 to fit within the cavity of the wheel 10 with the rearward surface 46 of the web 32 of the wheel liner 30 abutting against the outer surface 28 of the web 12 of the wheel 10, while the forward edge 38 of the wheel liner fits within the lip 16 of the wheel 10 as shown in FIG. 2.

In accordance with the invention, the rearward surface 46 of the web 32 of wheel liner 30 is adapted to abut against the forward outer surface 28 of the web 12 of the wheel and a suitable adhesive is applied between the two surfaces to retain the wheel cover 30 to the wheel 10. I have found that one means of permanently securing a wheel liner 30 into the cavity of wheel 10 is to apply a double sided tape 45 to the forward surface of the web 12 of the wheel 10 and thereafter pressing the rearward surface 46 of the web 32 of the wheel liner 30 against the exposed adhesive material of the double sided tape 45 to thereby retain the parts together.

Where the outer diameter of the central portion 36 of the wheel liner 30 is in close proximity to the inner diameter of the drop center 18, an adhesive 50, preferably in the form of a gel, can be applied to the parts prior to assembly to bond the outer surface of the central portion 36 of the wheel liner 30 to the drop center 18 of the wheel 10, thereby further securing the wheel liner 30 into the cavity of the wheel 10.

In the preferred embodiment, the wheel liner 30 has a central opening 52 sized to receive the central portions of the hub of a vehicle and surrounding the central opening 52 is a plurality of spaced holes 54-54 configured to received the studs, not shown, that retain the wheel 10 to hub, not shown, of the vehicle. Preferably, the spaced holes 54-54 have inner diameters that are sufficiently large to permit the inspection of the underlying metal of the wheel 10 in the proximity of the holes 26-26 in the wheel 10 that receives the studs. The holes 54-54 must, therefore, have a diameter larger than the widest diameter of the lug nuts retaining the wheel 10 to the vehicle to thereby leave a portion of the underlying metal of the wheel surrounding the lug nut visible for inspection.

Once the wheel liner 30 is installed into the cavity of the wheel 10, it will remain installed as a permanent part of the wheel 10 for the remainder of its useful life. Removal of the wheel 10 from the vehicle will not require the removal of the wheel liner 30 from the wheel 10.

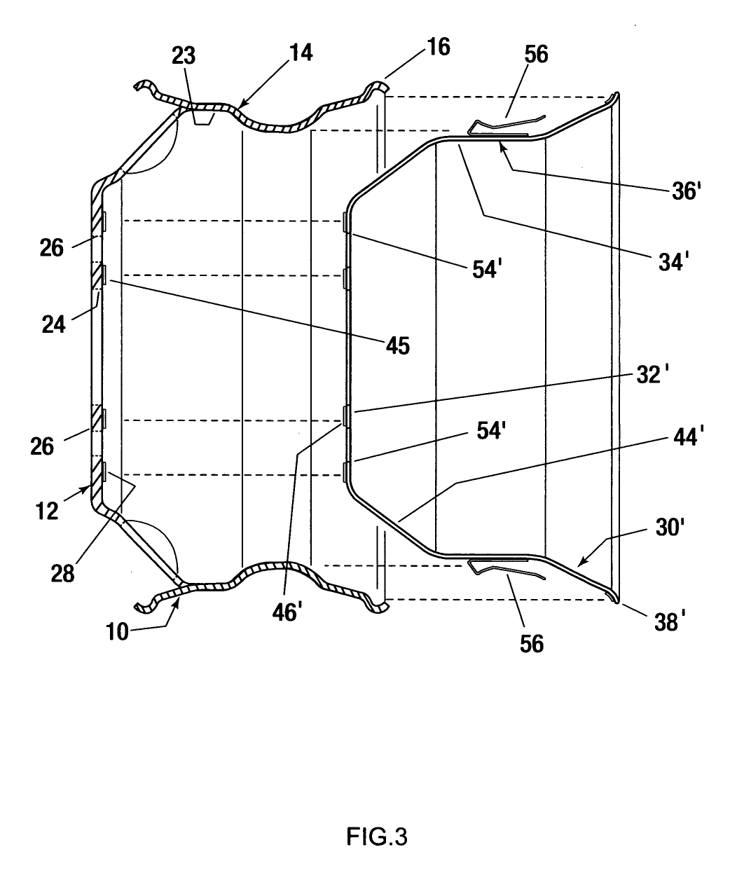

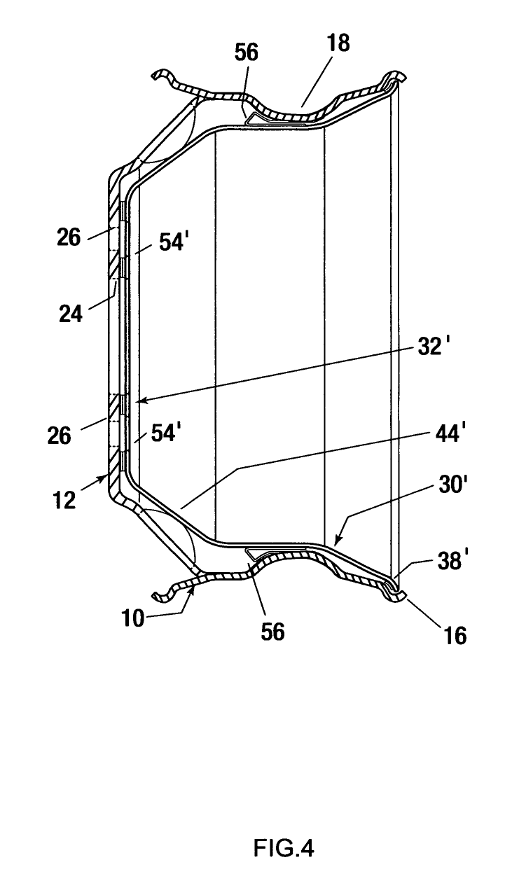

A second embodiment of a wheel liner 30′ in accordance with the invention is depicted in FIGS. 3 and 4. In this embodiment, the elements of the wheel are identical to the elements of wheel 10 described with respect to the first embodiment and the elements of the wheel liner 30′ that are identical to the elements of the wheel liner 30 described for the first embodiment bear identical indicia numbers except that they are primed.

In this second embodiment, a plurality of spring clips 56-56 are provided around the outer surface of central section 36′ of the tubular portion 34′ of the wheel liner 30′. The spring clips 56-56 are biased to be compressed against the inner shoulder 20 of the wheel 10 to thereby provide support to the tubular portion 34′ of the wheel liner 30′ when the wheel liner 30′ is inserted into the cavity of the wheel 10. The spring clips 56-56, therefore, are an alternative to the application of an adhesive, such as the gel adhesive 50 applied between the central section 36 of the wheel liner 30 and the drop center 18 of the wheel 10.

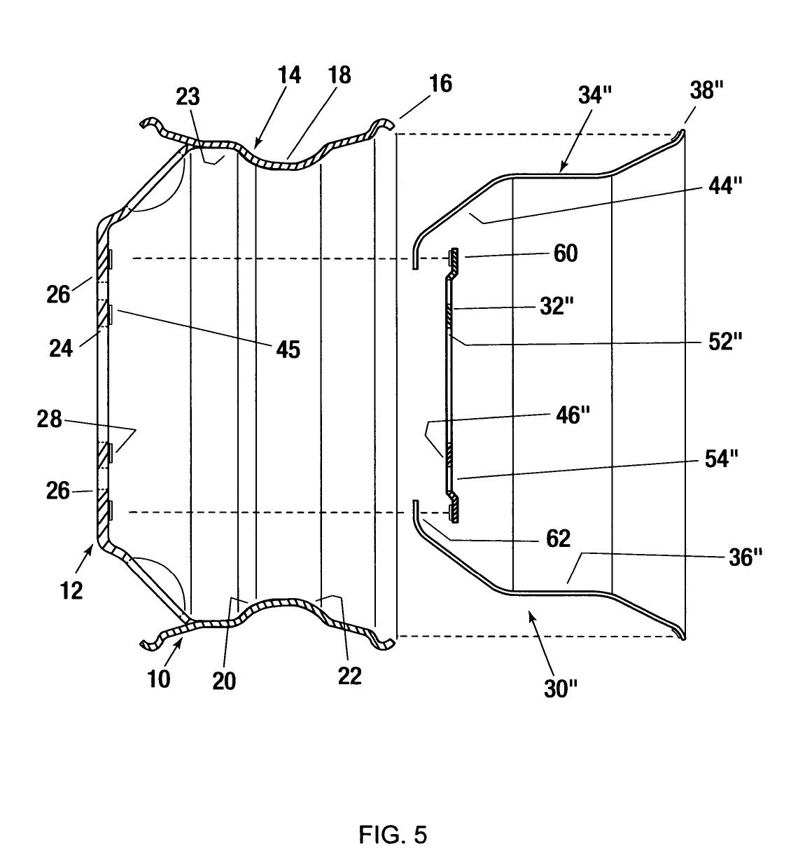

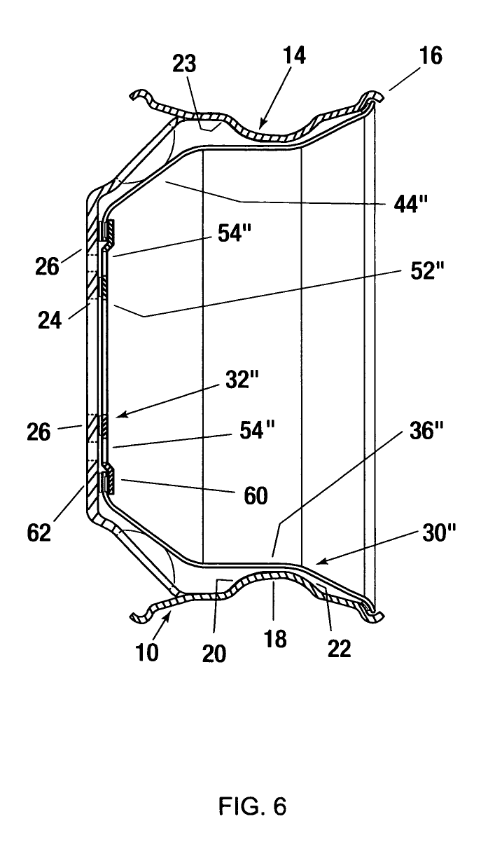

Yet a third embodiment of a wheel liner 30″ in accordance with the invention is depicted in FIGS. 5 and 6 in which the elements of the wheel bear identical indicia numbers to the wheel 10 depicted in FIG. 1 and in the elements of the wheel liner 30″ that are identical to the elements of the wheel liner 30 bear identical indicia numbers except that they are double primed. In this embodiment, the web 32″ of the wheel liner 30″ is a separate part from the tubular portion 34″. The web portion 32″ is generally planar with a circular outer lip 60 extending around the outer edge thereof. The lip 60 includes a shoulder sized to overlap an inwardly extending flange 62 at the rearward end of the tubular portion 34″ of the wheel liner 30″. Accordingly, the lip 60 of the web 30″ permits the rearward surface 46″ thereof to abut against the forward surface 28 of the web 12 of the wheel 10. When the parts are assembled together, the shoulder of lip 60 of the web 32″ will engage the inwardly directed flange 62 of the tubular portion 34″ thereby retaining the tubular portion 34″ inside the cavity of the wheel 10.

It should be appreciated that many different types and makes of trucks are manufactured to receive the same size tire and the wheels of the various truck manufacturers intended to receive the same size tire appear to the naked eye to be identical to one another. Even though they may appear to be identical, some of the dimensions of the inner surfaces of the rim 14 of the various wheels are different from one another. The outermost dimensions of the tubular portion 34, 34′, 34″ of a wheel liner 30, 30′, 30″ can be made to fit the smallest of the wheels 10 manufactured to receive a given sized tire, such that the same wheel liner 30, 30′, 30″ may be used to fit all wheels of a given size regardless of the manufacturer.

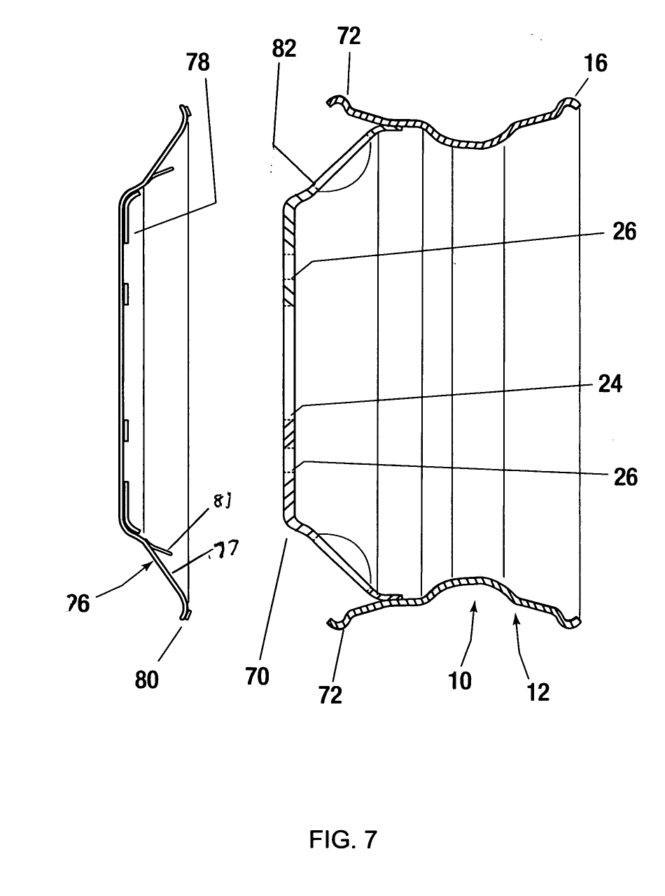

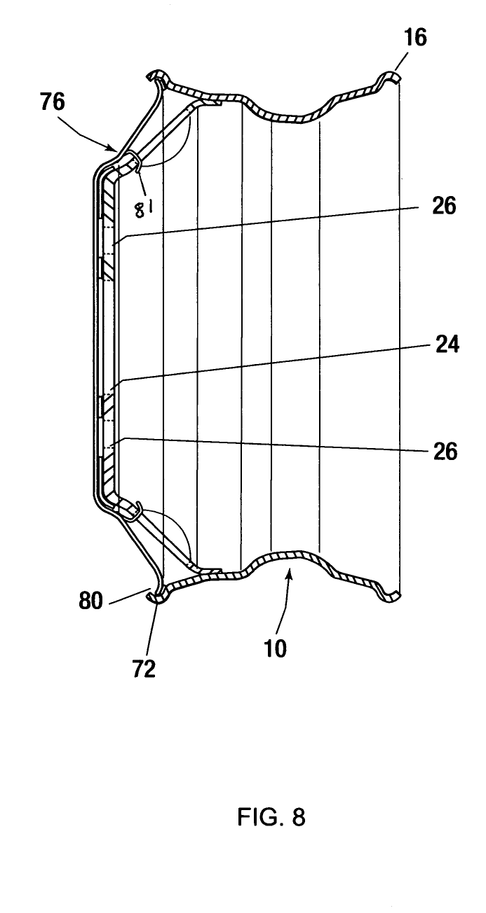

It should also be appreciated that the present invention can be employed to provide a wheel cover to the front wheels of a truck. Referring to FIGS. 7 and 8, when the wheel 10 is reversed to fit on the front axle of a truck the central opening 24 and the spaced holes 26-26 are visible as is the dome shaped opposite surface 70 of the web 12. Like the prior embodiments, the elements of the wheel bear the same indicia numbers as the wheel 10 shown in FIG. 1. A bead seat 72 having a curled outer end retains the bead of a tire, not shown. A wheel cover 76 in accordance with the invention has a stamped metal body with a rear surface 77 that is complementary in shape to the domed surface 70 of the wheel 10 such that the rear surface 77 will abut against the domed surface 70. The wheel cover 76 also has a central opening 24 and a plurality of spaced holes 26 to receive the studs that retain the wheel to the vehicle with the holes 26 being sufficiently large to permit the inspection of the metal of the underlying wheel surrounding the lug nuts that retain the wheel. The wheel cover 76 has a circular outer end 80 sized and configured to fit within the bead seat 72 so as not to interfere with the use of a tool, not shown, to remove a tire from the rim 14 of the wheel 10. As with the prior embodiments, a suitable adhesive means 78 is provided between the surfaces 70, 77 to bond the parts together. A plurality of bendable tabs 81 are adapted to extend through the openings of hand holes 82 to aid in the alignment of the parts as they are assembled.

While the present invention is described with respect to a plurality of embodiments, it will be appreciated that many more modifications and variations may be made without departing from the true spirit and scope of the invention. It is therefore the intent of the appended claims to cover all such modifications and variations which fall within the true spirit and scope of the invention.

1. A covering for a wheel of a vehicle where said wheel has a generally planar web surrounded by a tubular rim, said rim having an inner surface and said web having an outer surface and a central opening for receiving a central portion of an axle of said vehicle, said covering comprising
a body having a web portion,
said web portion having a rear surface complementary in shape to said outer surface of said web of said wheel, and
means for bonding said rear surface of said web portion to said outer surface of said web of said wheel.

2. The cover of claim 1 wherein said means for bonding will nonremovably bond said rear surface of said web portion to said outer surface of said web of said wheel.

3. The cover of claim 1 wherein said wheel has an outer lip for retaining the bead of a tire and said body has an outer end having a diameter a little less than said outer lip of said wheel wherein said cover will not interfere with the use of a tool used to remove said tire from said wheel.

4. The cover of claim 1 where said wheel has a plurality of holes spaced around said central opening for receiving a corresponding plurality of parallel spaced threaded studs for retaining said wheel to a vehicle and said web portion of said cover does not cover a portion of said web of said wheel in the proximity of said said plurality of said holes wherein the metal of said wheel around said plurality of spaced holes can be inspected without removing said cover from said wheel.

5. The cover of claim 1 wherein said cover is made of metal.

6. The cover of claim 1 and said body further comprises a tubular portion having an outer diameter less than an inner diameter of said tubular rim wherein said tubular portion of said body will nest within said tubular rim when said rear surface of said web portion is bonded to said outer surface of said web of said wheel.

7. The cover of claim 6 and further comprising means between said tubular portion of said body and said tubular rim for nonremovably retaining said tubular portion of said body within said tubular rim.

8. The cover of claim 6 wherein said web portion and said tubular portion are separate parts, and further comprising means on said web portion and on said tubular portion for retaining said tubular portion within said rim while said web portion of said cover is bonded to said outer surface of said web of said wheel.

9. The method of covering the visible portions of a wheel of a vehicle where said wheel has a generally planar web surrounded by a tubular rim, said web having an outer surface and a central opening for receiving a central portion of an axle of said vehicle, said method comprising the steps of
providing a wheel liner where said wheel liner has a web portion having a central opening with a diameter at least as large as said central opening in said web of said wheel and having a rear surface complementary in shape to at least a portion of said outer surface of said web of said wheel, wherein said wheel liner will fit against said wheel with said rear surface of said web of said wheel liner abutting said outer surface of said web of said wheel,
providing means for bonding said rear surface of said web of said wheel liner to said outer surface of said web of said wheel, and
bonding said rear surface of said rear surface of said web of said wheel liner to said outer surface of said web of said wheel.

10. The method of claim 9 wherein said means for bonding will nonremovably bond said rear surface of said web of said wheel liner to said outer surface of said web of said wheel.

11. The method of claim 9 wherein said wheel has an outer lip for retaining the bead of a tire and said wheel liner has an outer end having a diameter a little less than said outer lip of said wheel wherein said cover will not interfere with the use of a tool used to remove a tire from said wheel.

12. The method of claim 9 wherein said rim has an inner surface, and said wheel liner is provided having a tubular portion having an outer diameter less than said inner diameter of said inner surface and comprising the further step of
nesting said tubular portion of said wheel liner within said inner surface of said rim.

13. The method of claim 12 and comprising the further step of nonremovably joining said tubular portion of said wheel liner to said inner surface of said rim.

14. The method of claim 12 wherein said tubular portion of said wheel liner is provided as a separate part from said web portion of said wheel liner.

15. The method of covering the visible portions of a wheel of a vehicle where said wheel has a generally planar web surrounded by a tubular rim, said rim having an inner surface and said web having an outer surface and a central opening for receiving a central portion of an axle of said vehicle, said method comprising the steps of
providing a wheel liner where said wheel liner has a generally cylindrical portion having a circular inner end and a circular outer end and a planar web extending across said inner end of said cylindrical portion, said web having a central opening with a diameter at least as large as said central opening in said web of said wheel and having a rear surface complementary in shape to at least a portion of said outer surface of said web of said wheel,
providing means for bonding said rear surface of said web of said wheel liner to said outer surface of said web of said wheel, and
bonding said rear surface of said rear surface of said web of said wheel liner to said outer surface of said web of said wheel.
